(19) United States
(12) Patent Application Publication
(10) Pub. No.: US 2009/0056424 A1
(43) Pub. Date: Mar. 5, 2009

(54) Microscope Rheometer for Measuring Shear and Compression Properties of Biological Samples

(75) Inventors: Itai Cohen, Ithaca, NY (US); Mark Buckley, Ithaca, NY (US)

Correspondence Address: MILLER, MATTHIAS & HULL, ONE NORTH FRANKLIN STREET, SUITE 2350, CHICAGO, IL, 60606, US

(73) Assignee: Cornell Research Foundation, Inc., Ithaca, NY (US)

(21) Appl. No.: 12/194,224

(22) Filed: Aug. 19, 2008

Related U.S. Application Data
(60) Provisional application No. 60/968,797, filed on Aug. 29, 2007.

(51) Int. Cl. G01N 11/10

(52) U.S. Cl. 73/54.37

(57) ABSTRACT

A microscope rheometer for measuring shear and compression properties of biological samples is disclosed. The apparatus allows a sample of biological tissue to be strained controllably while fluorescently stained cells, or other markers, within the material are imaged with a fluorescence microscope and the applied forces are measured with a strain gauge. Using the rheometer, it is possible to obtain the shear and compression stiffness of a material as a function of position.

### CROSS-REFERENCE TO RELATED APPLICATION

This is a non-provisional patent application claiming priority under 35 U.S.C. 119(e) to U.S. Provisional Patent Application Ser. No. 60/968,797, filed on Aug. 29, 2007.

### FIELD OF THE DISCLOSURE

The present disclosure relates to rheometers for measuring shear and compression properties and, more particularly to microscope rheometers for measuring shear and compression properties of biological samples.

### BACKGROUND OF THE DISCLOSURE

Many biological tissues are highly complex and inhomogeneous in their structure and composition. As a result, their mechanical properties exhibit clear spatial variations. Determining these location-dependent mechanical properties and understanding their biological function is critical for tissue engineers attempting to create replacement tissues that mimic the properties of native tissue as closely as possible. In addition, the ability to compare the spatial dependence of mechanical properties in healthy and damaged tissue may provide insight into the effects of wear or disease.

As a particular example, articular cartilage, the soft connective tissue that coats bones in joints, has a structure that is highly dependent on depth from the articular surface. In vivo, this tissue is constantly subject to both shear and axial forces. However, the frequency and depth dependence of its shear and compression properties are poorly understood. Given the fact that cartilage damage due to osteoarthritis exhibits clear spatial variations, measuring the spatially dependent shear and compression properties in healthy and diseased articular cartilage could aid our understanding of the origin of osteoarthritis and assist in the development of a sensitive diagnostic tool for this disease.

Unfortunately, performing these measurements is difficult. The most commonly used method is to test partial thickness sections cut from different regions of the tissue. However, this technique is coarse and cannot resolve small scale variations in mechanical properties. In 1996, Schinagl et al. developed a method for measuring fine variations in axial strain in compressed samples of articular cartilage using video microscopy. The idea was to image these compressed cartilage explants under a fluorescence microscope and track tissue deformation using fluorescently stained cells as markers. Even so, this apparatus cannot be used to measure the spatial dependence of shear mechanical properties, which poses a particular challenge to researchers due to the difficulty of gripping soft biological tissue.

In light of the foregoing, there is a need for a robust device that combines the ability to image cells within a sample of biological tissue with simultaneous force transduction and control of shear and compression, thereby allowing researchers to measure fine spatial variations in the mechanical properties of these materials.

### SUMMARY OF THE DISCLOSURE

In accordance with one aspect of the disclosure, a microscope rheometer is provided which comprises a biaxial translation stage; a load cell coupled to the biaxial translation stage; a first shearing plate coupled to the load cell; a second shearing plate opposed to the first shearing plate; and a transducer coupled to the second shearing plate.

In accordance with another aspect of the disclosure, a microscope rheometer is provided which comprises a base supporting a translation stage and a piezoelectric transducer, the translation stage having a translation arm; a load cell coupled to the translation arm; a first shearing plate coupled to the load cell; and a second shearing plate opposed to the first shearing plate and coupled to the piezoelectric transducer.

In accordance with another aspect of the disclosure, a method for measuring shear and compression properties of a stained sample is provided. The method comprises the steps of placing the stained sample between two shearing plates; controlling at least one of the two shearing plates using a piezoelectric transducer; applying a shear and compression to the sample; measuring forces using a load cell; and tracking sample deformations using an imaging microscope.

These and other aspects of this disclosure will become more readily apparent upon reading the following detailed description when taken in conjunction with the accompanying drawings.

### BRIEF DESCRIPTION OF THE DRAWINGS

FIG. 1 is a perspective schematic view of a rheometer constructed in accordance with the teachings of the disclosure;

FIG. 2 is a side view of the rheometer shown in FIG. 1;

FIG. 3 is a top view of the rheometer shown in FIG. 1;

FIG. 4 is another perspective view of the rheometer shown in FIG. 1;

FIG. 5 is another perspective view of the rheometer shown in FIG. 1;

FIG. 6 is a sectional schematic view of a sample of biological tissue with fluorescently stained cells loaded into the disclosed device and subjected to shear;

FIG. 7 is a perspective view of another rheometer according to another embodiment enclosed herein;

FIG. 8 is a perspective view of another rheometer according to another embodiment enclosed herein, mounted to an inverted fluorescence microscope; and

FIG. 9 is a perspective view of yet another rheometer constructed in accordance with the teachings of the disclosure.

While the present disclosure is susceptible to various modifications and alternative constructions, certain illustrative embodiments thereof have been shown in the drawings and will be described below in detail. It should be understood, however, that there is no intention to limit the present invention to the specific forms disclosed, but on the contrary, the intention is to cover all modifications, alternative constructions, and equivalents falling with the spirit and scope of the present invention.

### DETAILED DESCRIPTION

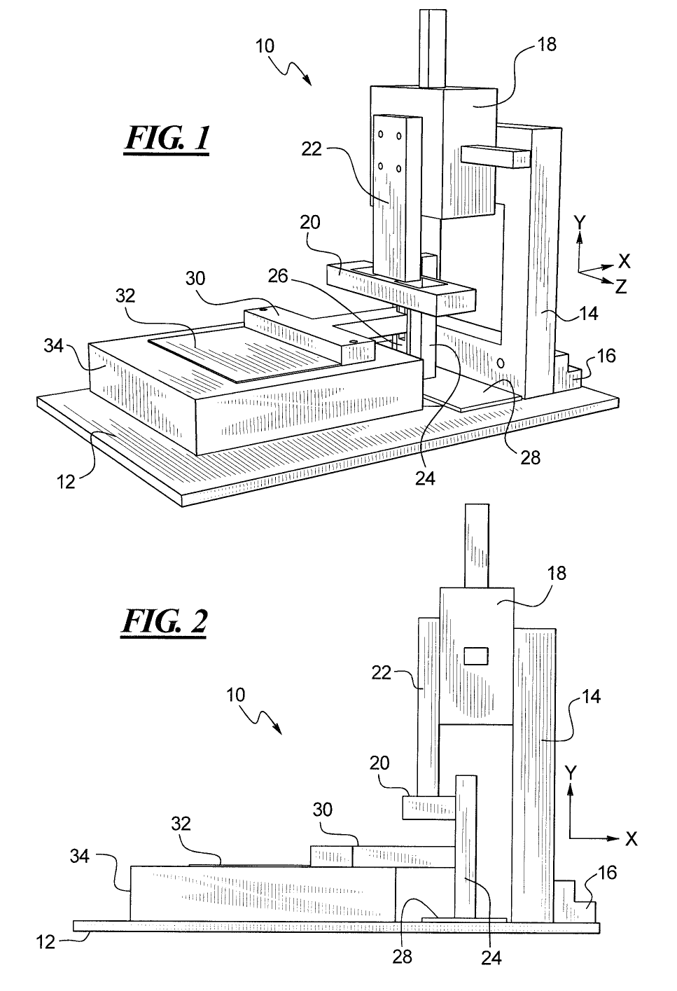

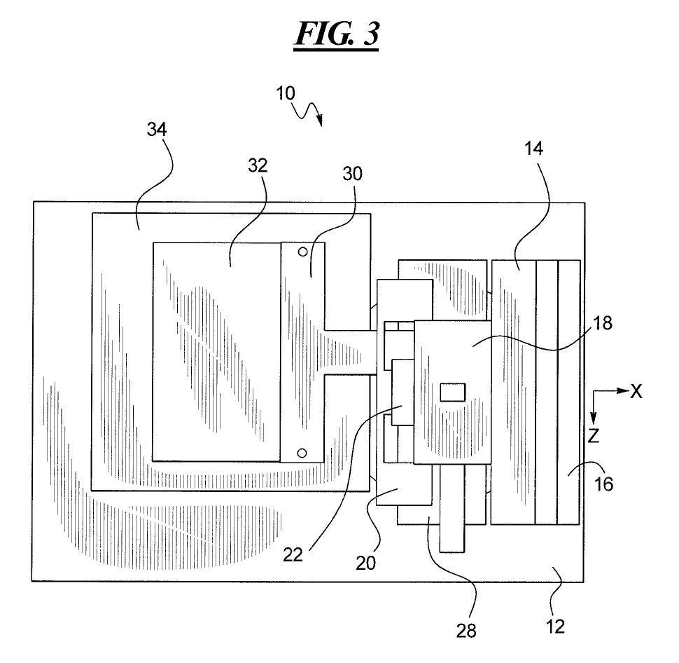

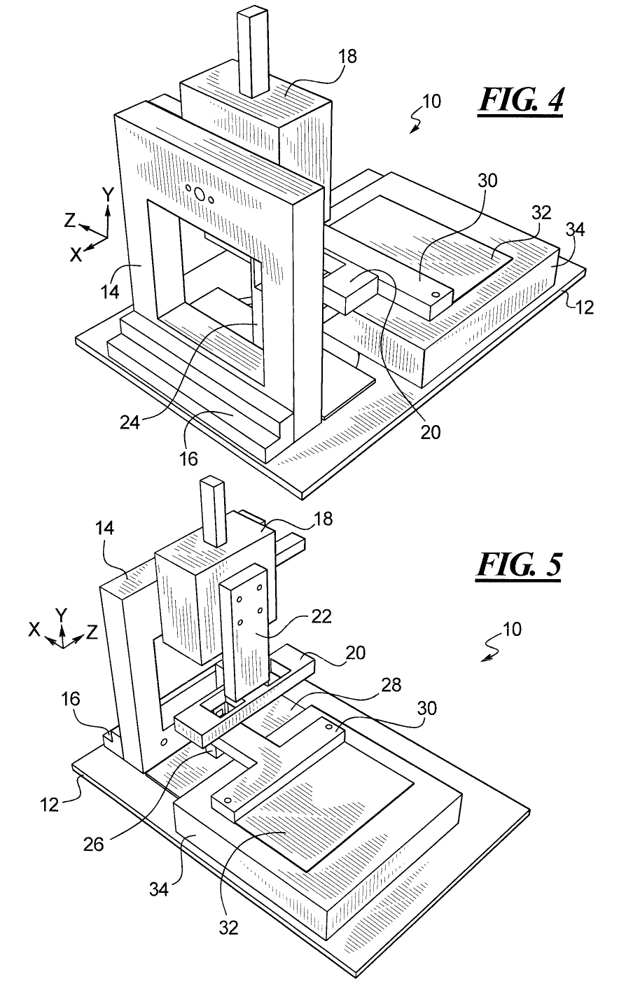

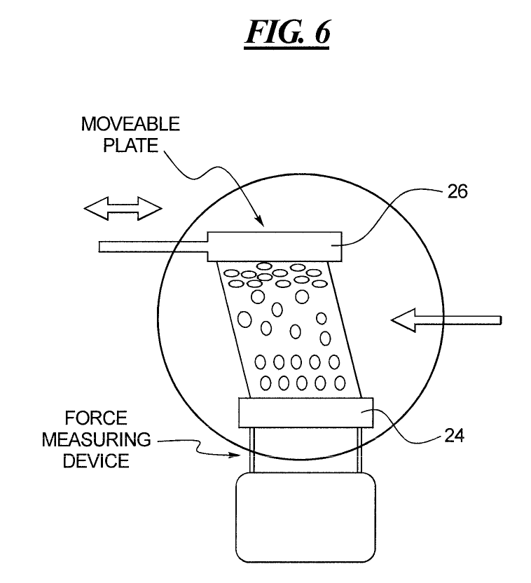

Referring now to the drawings and with particular reference to FIGS. 1-5, an exemplary rheometer for testing shear with a fluorescence microscope is generally referred to as reference numeral 10. It is to be understood that the teachings of the disclosure can be used to construct rheometers and other testing equipment above and beyond that specifically disclosed below. One of ordinary skill in the art will readily understand that the following are only exemplary embodiments.

The rheometer 10 may include a support base, such as a microscope adapter plate 12, to provide support for the rheometer 10 and adapt the rheometer 10 to a microscope stage. A frame 14 formed of light metals, such as aluminum or the like, may be detachably coupled to the base 12. Specifically, as oriented in FIGS. 1-5, the frame 14 may be allowed to slide along the x direction relative to the base 12. The frame 14 may also include an opening to allow access to handscrews used for adjusting and fastening various components of the rheometer 10. An optional lock 16 may adjustably lock the frame 14 into a desired position on the base 12. Alternatively, the frame 14 may be fixedly disposed on the microscope adapter plate 12, in which case the lock 16 may be omitted.

A translation stage 18 may be coupled to the frame 14. As shown in FIGS. 1-5, the exemplary translation stage 18 may be biaxial and capable of translations in they and z directions. A load cell 20 may be coupled to the translation stage 18 via an extension or a translation arm 22. Alternatively, the translation arm 22 may be omitted, in which case the load cell 20 may be coupled directly to the translation stage 18. As oriented in FIGS. 1-5, the load cell 20 may measure forces in the x and z directions and provide various feedback. The load cell 20 may be a commercial product such as an S300 model load cell offered by Strain Measurement Devices, Inc., of Meriden, Conn. The rheometer 10 may certainly employ other load cells.

Still referring to FIGS. 1-5, two plates, such as a first shearing plate 24 and a second shearing plate 26, may be provided by the rheometer 10 and situated over a glass slide 28, or the like. The first shearing plate 24 may be adjustably fastened to the load cell 20 using a handscrew, or the like. Specifically, the first shearing plate 24 may comprise a thru-hole and the load cell 20 may comprise a corresponding threaded hole through which a handscrew may be tightened. The second shearing plate 26 may be configured to oppose the first shearing plate 24 and held in place by an adapter 30. As with the frame 14, the adapter 30 may be formed using light metals such as aluminum or similar materials. The adapter 30 may be used to couple the second shearing plate 26 to a movable region 32. Alternatively, the second shearing plate 26 may be coupled directly to the movable region 32 while omitting the adapter 30.

As shown in FIGS. 1-5, the movable region 32 may be attached to the piezoelectric transducer 34, which is in turn coupled to the base 12. The piezoelectric transducer 34 may serve to translate the movable region 32, and thus the second shearing plate 26 coupled thereto, along the x and y axes. The controlled movements of the second shearing plate 26 relative to the stationary first shearing plate 24 may provide controlled shear and compression to samples.

During testing, samples, such as biological tissue samples or the like, are placed in between plates 24, 26 and above the glass slide 28. A circular rim may be adhered to the glass slide and filled with water, phosphate buffered saline (PBS), or the like, thereby immersing the shearing plates 24, 26. This may be done to keep samples hydrated as experiments are performed. Adhesion of a sample to the first and second shearing plates 24, 26 may be achieved by using an appropriate glue corresponding to the sample type. In the case of biological tissue samples, an adhesive such as superglue or the Dermabond® brand adhesive, offered by the Ethicon division of Johnson & Johnson, may be used. Alternatively, coating the shearing plates 24, 26 with fine sandpaper, or the like, may provide comparative results. When using an adhesive, the shearing plates 24, 26 may be removed from the rheometer 10 prior to shearing by unscrewing corresponding handscrews. Once the sample is placed between the first and second shearing plates 24, 26, the shearing plates 24, 26 may be reattached to the rheometer 10 for shearing.

While the first shearing plate 24 may be stationary during experiments, its position may be adjusted before and after shear tests using the translation stage 18. As shown in FIGS. 1-5, the translation stage 18 may provide fine adjustments to they and z positions of the first shearing plate 24. The y position may correspond to the height of the first shearing plate 24 above a glass slide 28, while the z position may correspond to the separation between the shearing plates 24, 26 allowing control over axial compression. During a test, the movable region 32 may cause displacements in the position of the second shearing plate 26 with respect to the first shearing plate 24 upon application of a varying voltage signal to the piezoelectric transducer 34, or the like.

Turning to the exemplary schematic of FIG. 6, experiments may be conducted by first fluorescently staining particular markers within a sample. For example, if the sample is a tissue, cells or cell nuclei within the tissue may be stained as markers. Upon loading the sample onto the rheometer 10 as described above, the device 10 may be placed onto the stage of a microscope capable of fluorescence detection or other imaging techniques. Subsequently, the piezoelectric transducer 34 shown may be subjected to a time varying voltage, causing the movable second shearing plate 26 to displace accordingly. For example, by applying a sinusoidally varying voltage to the piezoelectric transducer 34, the second shearing plate 26 may be displaced along the x direction according to the relation:

d(t)=A sin(ωt) (1)

where d is the displacement of the shearing plate from its equilibrium position, A is the amplitude of oscillation and ω represents the frequency of oscillation.

Markers may be imaged with a microscope and tracked as the sample is deformed, as schematically depicted in FIG. 6. Using a technique such as particle tracking or particle image velocimetry (PIV), the time-dependent displacement field \vec{s}(\vec{r},t) of these markers may be readily obtained where vector \vec{r} represents a location inside the imaging plane. The shear strain field, for example, may be deduced using the relation:

$$γ ( \vec{r} , t ) = \frac{1}{2} ( \frac{\partial {s}_{x}}{\partial {r}_{y}} + \frac{\partial {s}_{y}}{\partial {r}_{x}} ) \qquad ( 2 )$$

and the complex shear modulus may be deduced according to the equation:

$${G}^{*} ( \vec{r} , ω ) = \frac{σ ( t )}{γ ( \vec{r} , t )} . \qquad ( 3 )$$

The above parameter represents the location and frequency dependent stiffness of the material under shear. In particular, the real part G′ defines the elastic energy density stored in the sheared material while the imaginary part G″ is proportional to the energy density dissipated in each cycle due to the viscosity of the material.

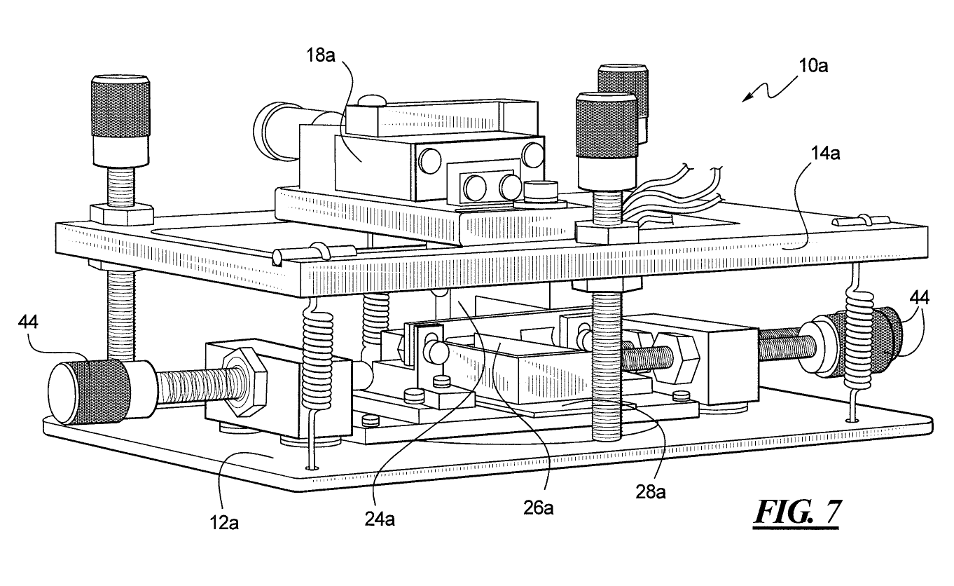

Referring now to FIG. 7, another exemplary rheometer 10a is provided having essentially the same characteristics as the rheometer 10 of FIGS. 1-5. Similarly, the rheometer 10a may include a microscope stage adapter 12a to serve as a support for the rheometer 10a and a glass slide 28a, and to also provide an interface for an inverted microscope. The rheometer 10a may also include a frame 14a which provides support for a translation stage 18a, and two shearing plates 24a, 26a disposed above the glass slide 28a. The position of the first shearing plate 24a may be adjusted by the translation stage 18a shown. In contrast to the previous embodiment 10 of FIGS. 1-5, the rheometer 10a may use finely threaded thumbscrews 44, rather than a transducer, to move the second shearing plate 26a and to shear samples.

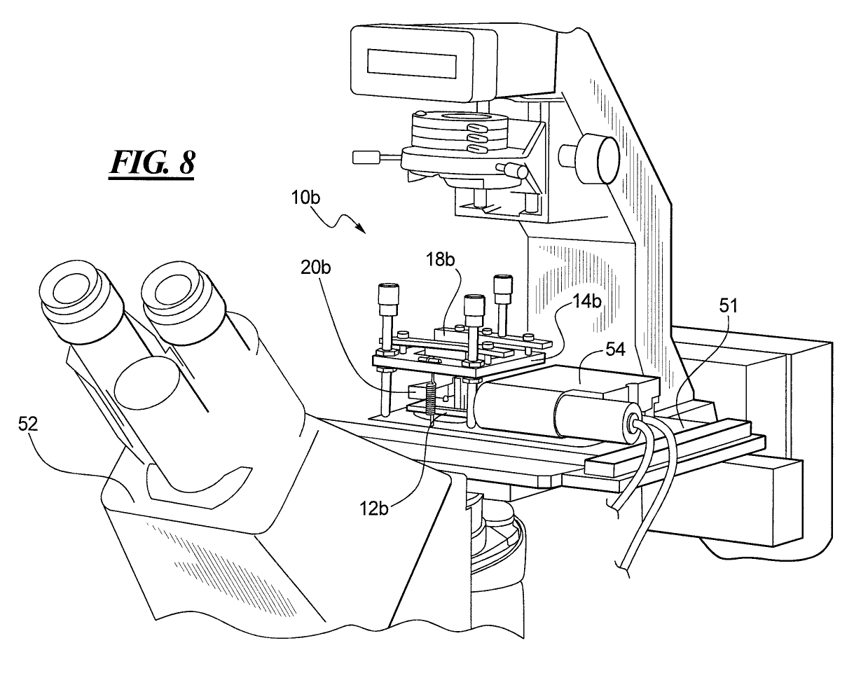

Referring now to FIG. 8, another embodiment 10b of the present disclosure is provided on a stage 51 of an inverted fluorescence microscope 52. The rheometer 10b shown is essentially the same as the embodiments 10 and 10a of FIGS. 1-7. Specifically, the rheometer 10b may include a microscope stage adapter 12b to provide an interface to the inverted microscope 52, a frame 14b supporting a translation stage 18b, a load cell 20b and two shearing plates, not shown. The load cell 20b may be coupled to a stationary first shearing plate to measure shear forces while a piezoelectric transducer 54 may serve to supply the shear via a movable second shearing plate. As previously discussed, a stained sample may be placed onto a glass slide and between the first and second shearing plates located towards the bottom of the rheometer 10b. During a test, the effects of shear and compression on the sample may be viewed from beneath the rheometer 10b and through an aperture of the microscope stage 51.

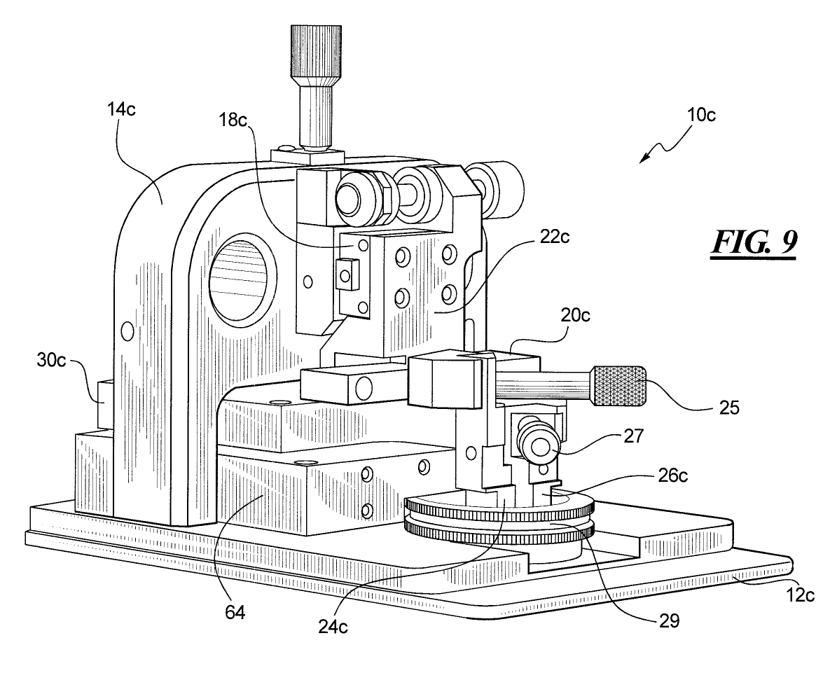

Referring now to FIG. 9, another rheometer 10c constructed in accordance with the present disclosure is provided. As with the previous embodiments 10, 10a and 10b of FIGS. 1-8, a microscope stage adapter 12c may provide support for the rheometer 10c as well as an interface for an inverted microscope. The rheometer 10c may also include a frame 14c for supporting a translation stage 18c and a translation arm 22c coupled thereto. A load cell 20c may be coupled to the translation arm 22c and configured to measure forces at a first shearing plate 24c. The first shearing plate 24c may be detachably coupled to the load cell 20c using a first thumbscrew 25 so as to allow fine adjustments to the position thereof. Similarly, a second shearing plate 26c may be positioned opposite the first shearing plate 24c and detachably coupled to an adapter 30c using a second thumbscrew 27. The adapter 30c may be coupled to the movable region of a piezoelectric transducer 64. Upon supplying the piezoelectric transducer 64 with a time varying voltage signal, the transducer 64 may displace the adapter 30c, and thus the second shearing plate 26c, relative to the fixed first shearing plate 24c correspondingly. Additionally, the rheometer 10c may include a circular rim 29 disposed about the shearing plates 24c, 26c to be filled with water, phosphate buffered saline (PBS), or the like, so as to immerse a portion of the shearing plates 24c, 26c. This may be done to maintain hydration of samples as experiments are performed.

Based on the foregoing, it can be seen that the present disclosure provides an apparatus allowing a sample of biological tissue, or other material samples, to be strained controllably while fluorescently stained cells, or other markers, within the material are imaged with a fluorescence microscope and the applied forces are measured with a strain gauge. In this way, the shear and compression stiffness of the material can be mapped as a function of position within two-dimensional imaging planes. Furthermore, if the studied material is homogeneous in the direction perpendicular to the imaging plane, the measured shear modulus profile will apply to the entire tissue.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A microscope rheometer, comprising:
a biaxial translation stage;
a load cell coupled to the biaxial translation stage;
a first shearing plate coupled to the load cell;
a second shearing plate opposed to the first shearing plate; and
a transducer coupled to the second shearing plate.

2. The microscope rheometer of claim 1, further including a base configured to engage a microscope stage.

3. The microscope rheometer of claim 1, wherein the load cell measures shear and compression forces applied to a sample.

4. The microscope rheometer of claim 1, further including an electronic memory and wherein the load cell is coupled to the memory.

5. The microscope of rheometer of claim 1, wherein the first shearing plate is stationary during a test.

6. The microscope rheometer of claim 1, wherein the shearing plates are coated with an adhesive.

7. The microscope rheometer of claim 1, wherein the shearing plates are coated with fine sandpaper.

8. The microscope rheometer of claim 1, wherein the first and second shearing plates further comprise a circular rim coupled around the shearing plates providing a reservoir to promote hydration of samples.

9. The microscope rheometer of claim 1, wherein the transducer is a piezoelectric transducer.

10. A microscope rheometer, comprising:
a base supporting a translation stage and a piezoelectric transducer, the translation stage having a translation arm;
a load cell coupled to the translation arm;
a first shearing plate coupled to the load cell; and
a second shearing plate opposed to the first shearing plate and coupled to the piezoelectric transducer.

11. The microscope rheometer of claim 10, wherein the translation stage adjustably positions the first shearing plate along two or more axes.

12. The microscope rheometer of claim 10, wherein the base is compatible with a microscope stage.

13. The microscope rheometer of claim 10, wherein the load cell measures shear and compression forces applied to a sample.

14. The microscope rheometer of claim 10, further including an electronic memory and wherein the signals for the piezoelectric transducer and the load cell are coupled to the memory.

15. The microscope rheometer of claim 10, wherein the first shearing plate is stationary during a test.

16. The microscope rheometer of claim 10, wherein the first and second shearing plates are coated with fine sandpaper.

17. The microscope rheometer of claim 10, wherein the first and second shearing plates further comprise a circular rim coupled around the shearing plates providing a reservoir to promote hydration of samples.

18. A method for measuring shear and compression properties of a stained sample, comprising the steps of:
placing a fluorescently stained sample between two shearing plates;
controlling at least one of the two shearing plates using a piezoelectric transducer;
applying a shear and compression to the sample;
measuring forces using a load cell; and
tracking sample deformations using a fluorescence microscope.

19. The method of claim 18, wherein the sample is adhered between the shearing plates using a glue suitable for biological tissue.

20. The method of claim 18, wherein a sinusoidally varying voltage is input to the piezoelectric transducer.

21. The method of claim 18, wherein a step function is input to the piezoelectric transducer.

22. The method of claim 18, wherein a sawtooth wave is input to the piezoelectric transducer.

23. The method of claim 18, wherein sample deformations are tracked using feature recognition tracking techniques.

24. The method of claim 18, wherein sample deformations are tracked using particle image velocimetry.
